(19) United States
(12) Patent Application Publication
(10) Pub. No.: US 2024/0053474 A1
(43) Pub. Date: Feb. 15, 2024

(54) Surveying Distance Measuring System Using Lasers

(71) Applicant: Johnson Level & Tool Mfg. Co., Inc., Mequon, WI (US)

(72) Inventor: Timothy J. Wojciechowski, Hubertus, WI (US)

(21) Appl. No.: 18/230,826

(22) Filed: Aug. 7, 2023

Related U.S. Application Data
(60) Provisional application No. 63/397,092, filed on Aug. 11, 2022.

(51) Int. Cl. G01S 17/26; G01S 7/484; G01S 7/481; G01C 15/00; G01S 7/4865

(52) U.S. Cl. CPC G01S 17/26; G01S 7/484; G01S 7/4813; G01C 15/002; G01S 7/4865

(57) ABSTRACT

A distance measuring system with a rotary laser generator and a laser detector. The rotary laser generator may rotate 360 degrees along a desired plane while emitting a rotating laser. The laser detector may be capable of detecting the rotating laser allowing the laser detector to be positioned along the same plane. Each detection of the rotating laser by the laser detector constitutes a pulse and the distance between the rotary laser generator and the laser detector may be calculated by the time measured between pulses. Additionally, the laser detector incorporates distance measuring technology providing the laser detector the capability to measure distances to surrounding objects. The laser detector also includes the ability to rotate so the laser detector may alternate from measuring the distance to a reference wall to the distance to the ground.

### CROSS-REFERENCE TO RELATED APPLICATIONS

This application claims the benefit of U.S. provisional patent application Ser. No. 63/397,092 filed Aug. 11, 2022, the entire disclosure and content of which is hereby incorporated by reference.

### BACKGROUND OF THE INVENTION

### 1. Field of the Invention

The invention relates to a system of surveying instruments used to measure distances between the instruments and the surrounding environment.

### 2. Discussion of the Related Art

Generally, surveying instruments are used in the construction industry. In construction, small measurement errors can cause large issues. Thus, there is a demand for surveying instruments that provide accurate distances. Additionally, a desire for efficiency on a construction site requires that measurement systems provide measurements quickly and with as few instruments as possible.

One common surveying instrument is a rotary laser generator. Often used to find and mark level planes, a rotary laser generator is commonly referred to as a rotary laser level. A typical rotary laser generator emits a laser, which is rapidly rotated 360 degrees. This laser rotation produces a level line of light on surrounding objects designating the plane of the laser. Surrounding objects may include, but are not limited to, walls, beams, and the ground. Generally, a rotary laser generator has a self-leveling feature or some other means known in the art used to fix the laser to a horizontal or vertical plane. This feature ensures the laser rotates around a level plane.

A rotary laser generator may also be used in tandem with other surveying instrumentation. For example, a location of interest may lack a reference object on which a level light line may be displayed. A surveying rod or other instrument may be used to provide a physical surface that makes the level line of light visible. A surveying rod may be a thin pole that is easily moved and can be positioned perpendicular with the ground at a desired location.

Additionally, rather than marking a plane using the visible light displayed on a physical object, an instrument with a sensor that can detect the laser may be used. An instrument capable of sensing a laser may be referred to as a laser detector. Similar to a surveying rod, a laser detector may be positioned at a location of interest. The laser detector may then sense when the laser detector is aligned with the plane that is produced by the rotary laser generator. If a laser detector is offset from the desired plane, the laser detector may also be capable of providing measurements to quantify this offset.

Once a rotary laser generator and a laser detector are aligned along a desired plane, the measurement of several distances may be required. First, it may be necessary to determine the distance from the rotary laser generator to the laser detector along the desired plane. Additionally, it may be necessary to know the distance from the laser detector to surrounding objects, such as a reference wall. Furthermore, when the desired plane is horizontal, the height from the ground of the rotary laser generator and the laser detector are equal. However, if the elevation of the site is uneven, it may also be necessary to know the distance from the laser detector to the ground. When using many of the surveying instruments on the market, these measurements are often not readily available or easily ascertainable.

One known method to measure these distances is to use a Laser Distance Measuring (LDM) instrument. An LDM instrument measures the distance from the instrument to a reference object using a well-known Time of Flight approach. Typically, an LDM instrument emits a laser pulse toward a reference object. The laser pulse hits the reference object and reflects back toward the LDM instrument. A sensor on the LDM instrument then receives the reflected laser pulse. Because the speed of the laser pulse is the speed of light, which is a constant, the distance between the LDM instrument and the reference object can be calculated by measuring the time it takes for the laser pulse to travel to the reference object and back to the LDM instrument. Generally, the equation used for an LDM instrument is distance equals the speed of light times the travel time divided by two.

However, use of an LDM instrument has its drawbacks, especially when used in conjunction with a rotary laser generator and a detector. LDM instruments are generally separate handheld devices, which requires the purchase, maintenance, and use of an additional instrument. Using an extra instrument may not be cost effective or the most efficient. Furthermore, handheld devices generally include some inherent human error because a human cannot hold a handheld device perfectly still or in an exact location.

Additionally, other measurement instruments on the market may require at least two users or may require a single user to move multiple positions. Some instruments may require adjustments or stabilization from multiple locations at one time, which makes more than one user necessary. While other instruments can be used by one user, the user may be forced to constantly move positions to obtain the necessary measurements.

### SUMMARY AND OBJECTS OF THE INVENTION

The disclosed invention addresses the above-identified issues by providing a system for measuring distances using lasers. The system includes a way to measure the distance from a rotary laser generator to a laser detector along a desired plane. Additionally, the system includes a way to measure distances from the laser detector to surrounding reference objects, such as reference walls and the ground.

First, the system may be set up along a desired plane. A rotary laser generator may be used in its common function as a rotary laser level to find the desired plane by rapidly rotating 360 degrees along the plane. A laser detector may then be used to detect the laser from the rotary laser generator allowing the laser detector to be positioned along the desired plane at a location of interest.

Once a rotary laser generator and a laser detector are positioned along a desired plane, the system can measure the distance from the rotary laser generator to the laser detector along the plane. Similar to a rotary laser generator's leveling operation, the rotary laser generator emits a laser and rapidly rotates the laser 360 degrees along the plane. The rate of rotation of the rotary laser generator may be known and may be designated in revolutions per minute (RPM). The known RPM of the rotary laser generator may then be communicated to the laser detector by some means known in the art.

With the rotary laser generator rotating and the laser detector aligned along the plane, the rotating laser from the rotary laser generator will align with the laser detector once per revolution. The laser detector will sense the rotating laser when the rotating laser aligns with the laser detector. Each time the laser detector senses the rotating laser may be referred to as a pulse. Each pulse has a corresponding time, which is measured by the laser detector.

The time between pulses may then be used to calculate the distance between the rotary laser generator and the laser detector. The time between pulses corresponds to the time it takes for the rotary laser generator to make one revolution plus the time for the rotating laser to travel from the rotary laser generator to the laser detector. The known rate of rotation may be used to calculate the time for one revolution, which then allows for the travel time of the rotating laser to be calculated. The rotating laser travels from the rotary laser generator to the laser detector at the speed of light, which is a constant. Therefore, the rotating laser travel time and the speed of light may be used to calculate the distance between the rotary laser generator and the laser detector. The rotating laser travel time times the speed of light equals this distance.

In addition to measuring the distance between the rotary laser generator and the laser detector, it may also be necessary to determine the distance from the laser detector to surrounding reference objects or surfaces. For example, it may be beneficial to find the distance from a laser detector to a reference wall. Additionally, it may also be necessary to measure the distance from a laser detector to the ground.

The laser detector may incorporate known measurement instrumentation to obtain these measurements. Laser Distance Measuring (LDM) is an example of one type of this measurement instrumentation. By incorporating LDM instrumentation into a laser detector, the laser detector may be able to measure distances to reference objects. Using LDM, a laser detector may emit a laser pulse toward a reference object, such as a wall. The laser pulse will hit the reference object and reflect back toward the laser detector. The laser detector may include an LDM sensor capable of detecting the reflected laser pulse. Because the speed of light is constant, the time it takes for the laser pulse to hit the reference object and reflect back to the laser detector may be used to measure distance. Generally, when using LDM technology, the distance the laser pulse travels is equal to the time of travel times the speed of light. Then, because the distance the laser pulse travels includes both the outgoing and incoming journey, the distance is divided by two.

Additionally, a laser detector may include the capability to rotate, for example by at least 90 degrees. This rotation may allow a laser detector to alternate, for example, between measuring the distance to a reference wall to measuring the distance to the ground. Representatively, in an LDM embodiment, the side of the laser detector that emits and receives a laser pulse would be rotated from aiming toward a reference wall to aiming toward the ground. This rotating function may provide the laser detector with the capability to measure desirable distances to a variety of different reference objects or surfaces.

One possible benefit to this distance measuring system is all the measurements may be displayed at the laser detector. That is, the laser detector may include a localized display that provides all the available measurements as outlined above, as well as other system parameters. This setup may allow for a single user to obtain multiple measurements using only the rotary laser generator and the laser detector without having to move positions. There may be no need for additional instrument operators or additional instruments.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

Representative exemplary embodiments of the invention are illustrated in the accompanying drawings in which like reference numerals represent like parts throughout, and in which:

FIG. 1 illustrates a side view of a rotary laser generator with a laser detector, which is aimed toward the ground.

FIG. 2 illustrates an overhead view of the rotary laser generator and laser detector as in FIG. 1, wherein the laser detector is rotated 90 degrees and aimed toward a surface such as a reference wall.

### DETAILED DESCRIPTION OF THE INVENTION

The present invention and the various features and advantageous details thereof are explained more fully with reference to the non-limiting embodiments described in detail in the following description.

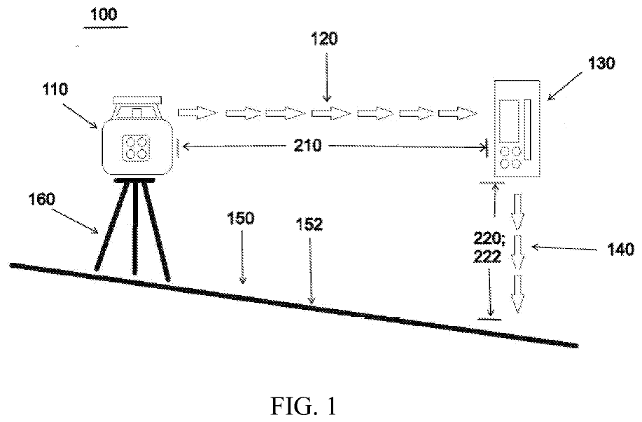

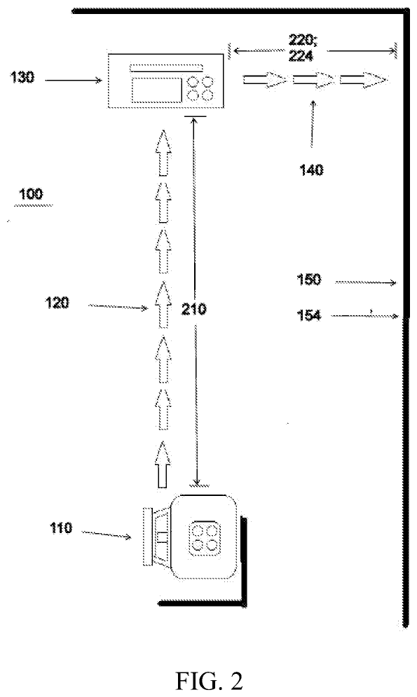

FIGS. 1 and 2 depict a distance measuring system 100 with a rotary laser generator 110 and a laser detector 130. Within this system, the laser detector 130 is able measure multiple distances, such as the distance between the rotary laser generator 110 and the laser detector 130, the distance between the laser detector 130 and a reference object or surface 150, the distance between the laser detector 130 and the ground 152, and the distance between the laser detector and a reference wall 154. Herein, these distances will be referred to as a laser-detector distance 210, a detector-reference distance 220, a detector-ground distance 222, and a detector-wall distance 224, respectively.

In FIGS. 1 and 2, the rotary laser generator 110 and the laser detector 130 are aligned on the same plane. These embodiments show the alignment being along the horizontal plane. Aligning the system along the horizontal plane may be common because the rotary laser generator 110 may also function as a rotary laser level, which may be used to find a level horizontal plane. However, other embodiments may align the rotary laser generator 110 and the laser detector 130 along a different plane, such as a vertical plane.

Generally, when setting up the system, a rotary laser generator 110 is positioned to have a laser emitted along a desired plane. This positioning may be accomplished using a self-leveling function or other known methods in the art of establishing a desired plane. The rotary laser generator 110 emits a rotating laser 120, which is rotated. The rotating laser 120 may rotate 360 degrees.

The laser detector 130 may then be placed in a desired location. The laser detector 130 includes a sensor that may detect a laser directed toward the laser detector 130. Thus, the laser detector 130 may detect the rotating laser 120 when the rotating laser 120 aligns with the laser detector 130. The height of the laser detector 130 may be adjusted so that the sensor aligns with the same plane as the rotating laser 120. In one embodiment, the sensor detecting the rotating laser 120 confirms that the rotating laser 120 and the laser detector 130 are aligned on the same plane. In another embodiment, the laser detector 130 may be capable of detecting the rotating laser 120 when the rotating laser and the laser detector 130 are not perfectly aligned on the same plane. The laser detector 130 may provide a displacement measurement designating the distance of the laser detector 130 from the plane of the rotating laser 120.

A rotary laser generator 110 and a laser detector 130 may be supported in a variety of different ways. The supports may minimize undesired movement. FIG. 1 depicts the rotary laser generator supported by a tripod stand 160. The laser detector 130 may also be supported by a similar stand. The supports may allow for the ability to adjust the height of the instruments. Additionally, the supports may be permanently attached to the instruments or may be detachable. In one embodiment, the support for one or both instruments may be a straight stick or rod held vertically by a user. In another embodiment, one or both instruments may be positioned on the ground 152 with no support at all.

### Measuring Distance Between the Rotary Laser Generator and the Laser Detector

FIGS. 1 and 2 depict an arrangement in which the laser-detector distance 210 may be measured. The rotary laser generator 110 may rotate the rotating laser 120 360 degrees. During each revolution, the laser detector 130 will detect the rotating laser 120 when the rotating laser 120 aligns with the laser detector 130. This detection may be referred to as a pulse. Therefore, each revolution of the rotating laser 120 generates a pulse, which has a corresponding time.

The laser detector 130 will use the difference in time between pulses to calculate the laser-detector distance 210. The time between each pulse and the known revolution speed of the rotary laser generator 110 may be used to derive the time it takes the rotating laser 120 to travel from the rotary laser generator 110 to the laser detector 130. This time for the rotating laser 120 to travel the laser-detector distance 210 may be referred to as the laser time of flight. Once the laser time of flight is known, the speed of light may be used to calculate the laser-detector distance 210.

The time between each pulse has two time variables: the time for one revolution of the rotary laser generator 110 and the laser time of flight. The time per revolution plus the laser time of flight is equivalent to the time between pulses. Because the time per revolution and the time between pulses may be measured and calculated, the laser time of flight may also be calculated.

The time per revolution may be calculated because the rate of rotation of the rotary laser generator 110 may be known. This known rotating speed may be communicated to the laser detector 130. Varying embodiments may communicate this rotating speed in a number of ways, such as via a manual input, a hardwired communication, cellular communication, Bluetooth, a signal sent via WiFi, or some other means known in the art. The rotating speed may be measured in revolutions per minute (RPM) and may be converted to the time per revolution as shown by the following equation:

$${t}_{rev} = \frac{1}{RPM ( \frac{min}{60 sec} )} , wherein :$$

$${t}_{rev} = time per revolution ( \frac{sec}{rev} ) ;$$

$$RPM = speed of rotation ( \frac{rev}{min} ) .$$

Varying embodiments of the rotary laser generator 110 may rotate at different speeds. Examples of possible rotating speeds include, but are not limited to, 300 RPM, 600 RPM, and 1,200 RPM. Additionally, in some embodiments, a rotary laser generator 110 may be capable of rotating at different speeds and the rotating speed may be an input variable.

Once the time per revolution is calculated, the laser time of flight may be calculated. The laser time of flight is equivalent to the time between pulses minus the time per revolution. The laser detector 130 measures the pulses and the corresponding pulse times. Thus, the laser detector 130 may produce the time between pulses. Because both variables are known, the laser time of flight may be calculated as shown by the following equation:

t_{ToF}=Δtₚᵤₗₛₑ−tᵣₑᵥ, wherein:

t_{ToF}=laser time of flight (sec);

Δtₚᵤₗₛₑ=time between pulses (sec).

After the laser time of flight is calculated, the laser-detector distance 210 may be calculated because the rotating laser 120 travels at the speed of light, which is a constant. The speed of light is equivalent to 299,792,458 m/s or 983,571,056 ft/s. The speed of light times the laser time of flight is equivalent to the laser-detector distance 210 as shown by the following equation:

$${x}_{L - D} = {t}_{T o F} * c , wherein :$$

$${x}_{L - D} = laser - detector distance ( ft ) ;$$

$$c = speed of light ( \frac{ft}{sec} ) .$$

Additionally, the time between pulses may be used to produce a frequency of pulses that correlates to the laser-detector distance 210. A cycle may be considered a single revolution of the rotary laser generator 110 plus the rotating laser 120 traveling to the laser detector 130. Therefore, the time of a cycle is the time between pulses. The inverse of the time of a cycle equals the frequency of pulses. This is shown with the following equation:

f=1/Δtₚᵤₗₛₑ, wherein:

f=frequency (Hz).

The laser detector 130 may use this frequency to determine the corresponding laser-detector distance 210.

### Example

Here is an example of calculating a corresponding frequency for this embodiment. Assume the rotary laser generator 110 rotates at 600 RPM and the laser-detector distance 210 is 500 ft. The frequency of pulses registered by the laser detector may be calculated by the following:

$${t}_{rev} = \frac{1}{RPM * ( \frac{min}{60 sec} )} = \frac{1}{600 ( \frac{r e ν}{min} ) * ( \frac{min}{60 sec} )} = 0.1 ( \frac{sec}{rev} ) ,$$

$${t}_{T o F} = \frac{{x}_{L - D}}{c} = \frac{5 \; 00 ( ft )}{983 , 571 , 056 ( \frac{ft}{sec} )} = 5.083 * 1 {0}^{- 7} ( sec ) = 0.5 \; 083 μ s ,$$

$$Δ {t}_{p u l s e} = {t}_{rev} + {t}_{T o F} = 0.1 ( sec ) + 5.083 * 1 {0}^{- 7} ( sec ) = 0.1000005083 ( sec ) ,$$

$$f = \frac{1}{{t}_{p u l s e}} = \frac{1}{0.1000005083} = 9.9999 \; 49 ( Hz ) .$$

If a laser detector were to measure this frequency, the inverse calculations could be done to calculate the laser-detector distance.

### Measuring Distance Between the Laser Detector and Reference Objects

In addition to the laser-detector distance 210, the distance measuring system may also provide distances from the laser detector 130 to a reference object 150. A reference object 150 may include the ground 152, a reference wall 152, or any other surrounding item. The laser detector-reference distances 220 include a detector-ground distance 222 and a detector-wall distance 224.

These distances may be measured by incorporating known measurement instrumentation into the laser detector 130. Rather than using a separate instrument to measure these distances, the laser detector 130 itself has this capability.

In one embodiment, the laser detector 130 may incorporate Laser Distance Measuring (LDM). LDM is a known measurement technology within the art. With LDM incorporated into a laser detector 130, the laser detector 130 may aim towards a reference object 150, such as the ground 152 or a reference wall 154. The laser detector 130 may emit a laser pulse 140 toward the reference object 150. The laser pulse 140 may hit the reference object 150 and reflect back towards the laser detector 130. The laser detector 130 may incorporate a sensor designed to receive or detect the reflected laser pulse 140. The laser detector 130 may measure the time between emitting the laser pulse 140 and detecting the reflected laser pulse 140.

A laser detector 130 that incorporates LDM technology may use this laser pulse 140 travel time to calculate the detector-reference distance 220. The laser pulse 140 travels at the speed of light, which is a constant. Therefore, the time for a laser pulse 140 to travel to a reference object 150 and back to the laser detector 130 may be used to calculate the detector-reference distance 220. Generally, the detector-reference distance 220 is equal to the following:

$${x}_{D - R} = \frac{{t}_{LP} * c}{2} , wherein :$$

$${x}_{D - R} = dectector - reference distance ( ft ) ;$$

$${t}_{LP} = laser pulse travel time ( sec ) .$$

As indicated by the equation, the laser pulse 140 travel time correlates to double the detector-reference distance 220 because the laser pulse 140 travels the distance twice, to the reference object 150 and back to the laser detector 130.

The laser detector 130 also incorporates a rotating function, which allows the laser detector 130 to measure distances in varying directions. Generally, distance measuring technology requires the instrumentation to be aimed in the direction of the desired distance, and toward an object or surface oriented so as to enable the laser beam to be reflected back toward the detector. Therefore, if a laser detector 130 incorporates distance measuring technology, the laser detector 130 may need to be aimed in a certain direction. In an embodiment in which the laser detector 130 incorporates LDM technology, one side of the laser detector 130 may emit and subsequently detect the laser pulse 140. This side may be referred to as the measuring side. The measuring side may require being aimed toward the desired distance, or in other words toward a reference object 150. Thus, the rotating function allows the laser detector 130 to alter the direction it is aiming.

Comparing FIGS. 1 and 2 demonstrates this rotating function. FIG. 1 depicts the measuring side of the laser detector aiming along the vertical plane down toward the ground 152. In this arrangement, the laser detector 130 may measure the detector-ground distance 222. In an LDM embodiment, a laser pulse 140 would be emitted vertically down toward the ground 152 and reflected upward toward the laser detector 130. This arrangement may be beneficial if the distance measuring system 100 is used in a location with uneven elevation. As shown in FIG. 1, while the rotary laser generator 110 and the laser detector 130 may be positioned on a level plane, the instruments' heights from the ground 152 at their respective locations may not be equal.

A change from FIG. 1 to FIG. 2 is the laser detector 130 in FIG. 2 is rotated 90 degrees relative to its position as shown in FIG. 1. In FIG. 2, the measuring side of the laser detector 130 faces a surface such as a reference wall, and measures the detector-wall distance 224. In an LDM embodiment, a laser pulse 140 would be emitted horizontally toward a reference wall 154 and reflected back toward the laser detector 130. This arrangement may be beneficial to determine the distance of the laser detector 130 to surrounding items in the area.

The rotating function may be accomplished by attaching the laser detector 130 to a rotating or pivot connection. Varying embodiments may include a rotating hinge, a swivel joint, a moveable pin, or some other rotating connection known within the art. The support for the laser detector 130 may be offset from the laser detector 130 so that the measuring side may aim downward without interference. Additionally, an embodiment may include a lock or a stabilizer for the rotation connection at varying rotation intervals, such as 90 degrees or 45 degrees. A lock or stabilizer may prevent unwanted movement of the laser detector 130 when measuring. Another embodiment may allow for more or less than 90 degrees of rotation. An embodiment may allow for 360 degrees of rotation. The laser detector 130 may include level and plumb vials for positioning the laser detector horizontally and vertically, respectively.

It is also contemplated that the laser detector 130 may incorporate two separate LDM distance measuring systems that emit and receive laser beams that are perpendicular to each other. In an embodiment such as this, the detector-wall distance 224 and the detector-ground distance 222 can be measured simultaneously, without the need to rotate the laser detector 130 on its supporting structure.

### Display of Measurements

A possible benefit of the distance measuring system 100 is the distances measured may be displayed on a local display on the laser detector 130, which includes a means to present the different distances that may be measured in the system. By including a display at the laser detector 130, a user may efficiently obtain all the desired measurements without moving between different instruments or positions. A localized display may present a laser-detector distance 210, a detector-ground distance 222, a detector-wall distance 224, or any other parameter the laser detector 130 may obtain, such as the rate of rotation for the rotary laser generator 110.

The laser detector 130 display may be a digital screen that provides readouts of distances and other parameters. The screen may be a liquid-crystal display (LCD). In one embodiment, the display may have the capability to display all measured distances simultaneously, or may toggle between different parameter outputs or options. A screen may also have touch screen capabilities or may be controlled by localized buttons on the laser detector 130. Additionally, the display may be capable of receiving inputs that control the system's operation. For example, a user may be able to select a desired rotary laser generator RPM using the display. The various measured parameters or distances may also be displayed on a screen of a mobile device using a software application on the mobile device, with the laser detector 130 and the mobile device being in communication via Bluetooth, Wi-Fi, cell signal or any other known means of communication.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

We claim:

1. A distance measuring system, comprising:
a rotary laser generator emitting a laser, wherein the laser rotates in a plane at a known RPM; and
a laser detector on the plane, wherein the laser detector is capable of sensing the laser when the laser aligns with the laser detector along the plane, wherein the sensing of the laser during rotation of the laser is designated as a pulse, and wherein at least two pulses are created during rotation of the laser having a time corresponding to each pulse;
wherein a distance between the rotary laser generator and the laser detector on the plane is calculated using the time corresponding to each pulse, the known RPM, and the speed of light.

2. The distance measuring system of claim 1, wherein the distance between the rotary laser generator and the laser detector is displayed on the laser detector.

3. The distance measuring system of claim 1, wherein the distance between the rotary laser generator and the laser detector is displayed on a mobile device via a wireless communication protocol and a software application on the mobile device.

4. The distance measuring system of claim 1, wherein the laser detector includes a laser distance measuring arrangement, wherein the laser distance measuring arrangement is configured to measure a distance between the laser detector and a surface other than in the plane in which the laser rotates.

5. The distance measuring system of claim 4, wherein the laser distance measuring arrangement measures the distance between the laser detector and the surface using a laser emitted from the laser detector and reflected from the surface toward the laser detector.

6. The distance measuring system of claim 5, wherein the orientation of the laser detector can be varied so as to measure a distance between the laser detector and a plurality of surfaces.

7. The distance measuring system of claim 6, wherein the laser detector can be oriented to measure a horizontal distance between the laser detector and a vertical surface, and can be further oriented to measure a vertical distance between the laser detector and a horizontal surface.

8. The distance measuring system of claim 5, wherein the laser distance measuring arrangement measures a first distance between the laser detector and a first surface using a first laser emitted from the laser detector and reflected from the surface toward the laser detector, and measures a second distance between the laser detector and a second surface using a second laser emitted from the laser detector and reflected from the surface toward the laser detector.

9. A method for measuring a distance between a rotary laser generator and a laser detector on a plane comprising:
emitting a laser from the rotary laser generator;
rotating the laser along the plane at a known RPM;
creating a pulse when the laser aligns with the laser detector along the plane, wherein at least two pulses are created having a time corresponding to each pulse; and
calculating the distance between the rotary laser generator and the laser detector on the plane using the time corresponding to each pulse, the known RPM, and the speed of light.

10. The method of claim 9, including displaying the distance between the rotary laser generator and the laser detector on the laser detector.

11. The method of claim 9, including measuring a distance between the laser detector and a surface other than in the plane in which the laser rotates.

12. The method of claim 11, wherein measuring the distance between the laser detector and the surface is carried out by measuring the distance between the laser detector and the surface using a laser emitted from the laser detector and reflected from the surface toward the laser detector.

13. The method of claim 12, including varying the orientation of the laser detector so as to measure a distance between the laser detector and a plurality of surfaces.

14. The method of claim 13, including orienting the laser detector to measure a horizontal distance between the laser detector and a vertical surface, and further orienting the laser detector to measure a vertical distance between the laser detector and a horizontal surface.

15. The method of claim 14, including measuring a first distance between the laser detector and a first surface using a first laser emitted from the laser detector and reflected from the surface toward the laser detector, and measuring a second distance between the laser detector and a second surface using a second laser emitted from the laser detector and reflected from the surface toward the laser detector.

16. A laser detector comprising:
a first sensor having the capability of detecting a laser signal emitted from an external source for measuring a first distance;
a measurement assembly having the capability of measuring a distance to a reference object;
wherein the measurement assembly comprises a laser generator having the capability of emitting an outgoing laser pulse toward the reference surface and a second sensor having the capability of detecting a reflected laser pulse from the reference surface in order to measure a second distance between the laser detector, wherein the second distance is the distance between the laser detector and the reference surface.

17. The laser detector of claim 16, wherein the first distance is measured using a rotary laser generator emitting a laser, wherein the laser rotates in a plane at a known RPM, a wherein the laser detector is on the plane, wherein the laser detector is capable of sensing the laser when the laser aligns with the laser detector along the plane, wherein the sensing of the laser during rotation of the laser is designated as a pulse, and wherein at least two pulses are created during rotation of the laser having a time corresponding to each pulse, wherein the first distance between the rotary laser generator and the laser detector is calculated using the time corresponding to each pulse, the known RPM, and the speed of light.

18. The laser detector of claim 17, wherein the orientation of the laser detector can be varied so as to measure a distance between the laser detector and a plurality of surfaces.

19. The distance measuring system of claim 18, wherein the laser detector can be oriented to measure a horizontal distance between the laser detector and a vertical surface, and can be further oriented to measure a vertical distance between the laser detector and a horizontal surface.

19. The laser detector of claim 16, wherein the distance between the rotary laser generator and the laser detector is displayed on the laser detector along with the second distance.
